(19) United States
(12) Patent Application Publication
(10) Pub. No.: US 2019/0347510 A1
(43) Pub. Date: Nov. 14, 2019

(54) Systems and Methods for Performing Facial Alignment for Facial Feature Detection

(71) Applicant: CyberLink Corp., Shindian City (TW)

(72) Inventors: Cheng-da (Darren) Chung, New Taipei City (TW); Yi-Hsin (Simon) Liu, Taipei City (TW)

(21) Appl. No.: 16/351,420

(22) Filed: Mar. 12, 2019

Related U.S. Application Data
(60) Provisional application No. 62/670,118, filed on May 11, 2018.

(51) Int. Cl. G06K 9/62; G06K 9/00; G06K 9/32

(52) U.S. Cl. CPC G06K 9/6203; G06K 2009/6213; G06K 9/3233; G06K 9/00281

(57) ABSTRACT

A computing device obtains a digital image depicting a facial region of an individual and performs a facial alignment algorithm to generate a facial alignment result depicted in a digital image to identify landmark facial features in the facial region. The computing device performs a facial recognition algorithm on the facial region to determine whether the facial region matches a facial feature definition previously-stored in a data store. The computing device generates descriptor data comprising an image patch within a region of interest and identifies a closest matching facial feature definition using the descriptor data. The computing device modifies a landmark facial feature based on the identified closest matching facial feature definition.

### CROSS-REFERENCE TO RELATED APPLICATION

This application claims priority to, and the benefit of, U.S. Provisional Patent Application entitled, “Systems and Methods for Facial Alignment,” having Ser. No. 62/670,118, filed on May 11, 2018, which is incorporated by reference in its entirety.

### TECHNICAL FIELD

The present disclosure generally relates to systems and methods for accurately performing facial alignment for facial feature detection.

### BACKGROUND

Accurate detection of facial landmark facial features is important for such applications as virtual application of makeup effects to facial features including the eyes, lips, cheeks, and so on. Although model-based facial alignment algorithms exist that rely on databases of pre-defined facial models, one perceived shortcoming with such algorithms is the finite number of models. Therefore, there is a need for an improved method for tracking facial features.

### SUMMARY

In accordance with one embodiment, a computing device obtains a digital image depicting a facial region of an individual and performs a facial alignment algorithm to generate a facial alignment result depicted in a digital image to identify landmark facial features in the facial region. The computing device performs a facial recognition algorithm on the facial region to determine whether the facial region matches a facial feature definition previously-stored in a data store. The computing device generates descriptor data comprising an image patch within a region of interest and identifies a closest matching facial feature definition using the descriptor data. The computing device modifies a landmark facial feature based on the identified closest matching facial feature definition.

Another embodiment is a system that comprises a memory storing instructions and a processor coupled to the memory. The processor is configured by the instructions to obtain a digital image depicting a facial region of an individual and perform a facial alignment algorithm to generate a facial alignment result depicted in a digital image to identify landmark facial features in the facial region. The processor is further configured to perform a facial recognition algorithm on the facial region to determine whether the facial region matches a facial feature definition previously-stored in a data store. The processor is further configured to generate descriptor data comprising an image patch within a region of interest and identify a closest matching facial feature definition using the descriptor data. The processor is further configured to modify a landmark facial feature based on the identified closest matching facial feature definition.

Another embodiment is a non-transitory computer-readable storage medium storing instructions to be implemented by a computing device having a processor, wherein the instructions, when executed by the processor, cause the computing device to obtain a digital image depicting a facial region of an individual and perform a facial alignment algorithm to generate a facial alignment result depicted in a digital image to identify landmark facial features in the facial region. The processor is further configured to perform a facial recognition algorithm on the facial region to determine whether the facial region matches a facial feature definition previously-stored in a data store. The processor is further configured to generate descriptor data comprising an image patch within a region of interest and identify a closest matching facial feature definition using the descriptor data. The processor is further configured to modify a landmark facial feature based on the identified closest matching facial feature definition.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device for performing facial feature detection in accordance with various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for performing facial feature detection according to various embodiments of the present disclosure.

FIG. 4 illustrates facial landmark facial features identified by the computing device in FIG. 1 according to various embodiments of the present disclosure.

FIG. 5 illustrates the computing device in FIG. 1 adjusting the location of a landmark facial feature according to various embodiments of the present disclosure.

FIG. 6 is a top-level flowchart for generating result files performed by the computing device of FIG. 1 whereby descriptor data is generated and stored in the data store for future use according to various embodiments of the present disclosure.

FIG. 7 is a top-level flowchart for utilizing previously-stored descriptor data for facial feature detection by the computing device of FIG. 1 according to various embodiments of the present disclosure.

FIG. 8 illustrates the use of previously-stored descriptor data according to various embodiments of the present disclosure.

### DETAILED DESCRIPTION

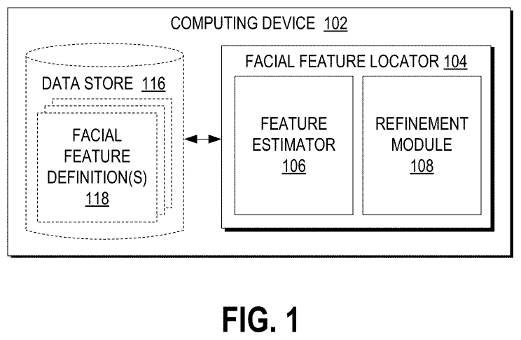

Various embodiments are disclosed for accurately detecting facial features by applying facial alignment and facial recognition techniques that utilize historical descriptor data. A description of a system for performing facial feature detection is now described followed by a discussion of the operation of the components within the system. FIG. 1 is a block diagram of a computing device 102 in which the techniques for performing facial feature detection disclosed herein may be implemented. The computing device 102 may be embodied as a computing device such as, but not limited to, a smartphone, a tablet computing device, a laptop, and so on.

A facial feature locator 104 executes on a processor of the computing device 102 and includes a feature estimator 106 and a refinement module 108. The feature estimator 106 is configured to obtain a digital image depicting a facial region of an individual. As one of ordinary skill will appreciate, the digital image may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats.

Alternatively, the digital image may be derived from a still image of a video encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats. The feature estimator 106 is further configured to perform facial alignment on the digital image and generate a result file comprising locations of facial landmark facial features in the facial region.

The refinement module 108 is configured to compare the facial feature definition generated from the result file to facial feature definitions 118 stored in a data store 116, where each of the facial feature definitions 118 comprises locations of facial landmark facial features of corresponding facial regions and refinement data for one or more of the locations of facial landmark facial features. In the context of the present disclosure, such refinement data reflects adjustments made to initial estimated locations of facial landmark facial features, wherein such adjustments were previously made to another digital image depicting the same facial region. Such historical refinement data is utilized by the computing device 102 to automatically perform adjustments to the locations of facial landmark facial features of a current digital image depicting the same facial region.

The refinement module 108 then performs various functions depending on whether the facial feature definition generated from the result file matches one of the facial feature definitions 118 in the data store 116. For example, if the facial feature definition generated from the result file matches one of the facial feature definitions 118, the refinement module 108 retrieves the matching facial feature definition 118 from the data store 116 and applies the refinement data contained in the matching facial feature definition 118 to a corresponding location of a facial landmark feature in the current digital image to generate a refined result file. The refined result file therefore contains a refined location for one or more facial landmark facial features.

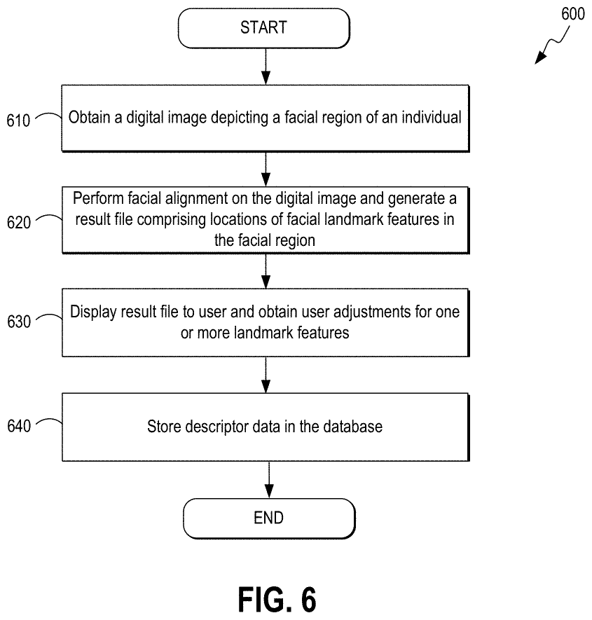

If no further refinement is needed for locations of any of the facial landmark facial features in the digital image, the refinement module 108 outputs the refined result file. If the facial feature definition generated from the result file does not match any of the facial feature definitions 118, the refinement module 108 determines that the facial region depicted in the current digital image is a new facial region. If necessary, the user adjusts the location of landmark facial features in the current digital image and stores the facial feature definition generated from the result file as a new facial feature definition 118 in the data store 116 for future use (as described in connection with block 630 in FIG. 6 below). Specifically, if another digital image later processed by the computing device 102 depicts the same facial region, the newly-created facial feature definition 118 may be utilized to automatically adjust the locations of one or more landmark facial features in the current digital image.

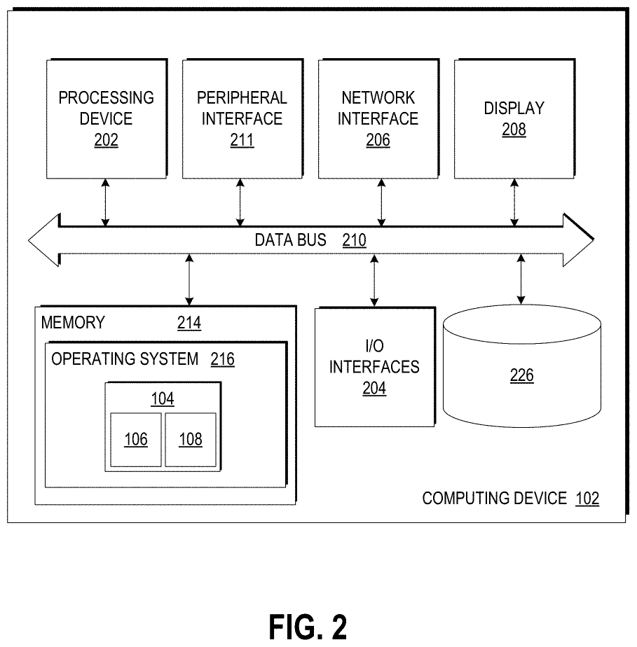

FIG. 2 illustrates a schematic block diagram of the computing device 102 in FIG. 1. The computing device 102 may be embodied in any one of a wide variety of wired and/or wireless computing devices, such as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include any custom made or commercially available processor, a central processing unit (CPU) or an auxiliary processor among several processors associated with the computing device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 depicted in FIG. 1. In accordance with such embodiments, the components are stored in memory 214 and executed by the processing device 202, thereby causing the processing device 202 to perform the operations/functions disclosed herein. One of ordinary skill in the art will appreciate that the memory 214 can, and typically will, comprise other components which have been omitted for purposes of brevity. For some embodiments, the components in the computing device 102 may be implemented by hardware and/or software.

Input/output interfaces 204 provide any number of interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

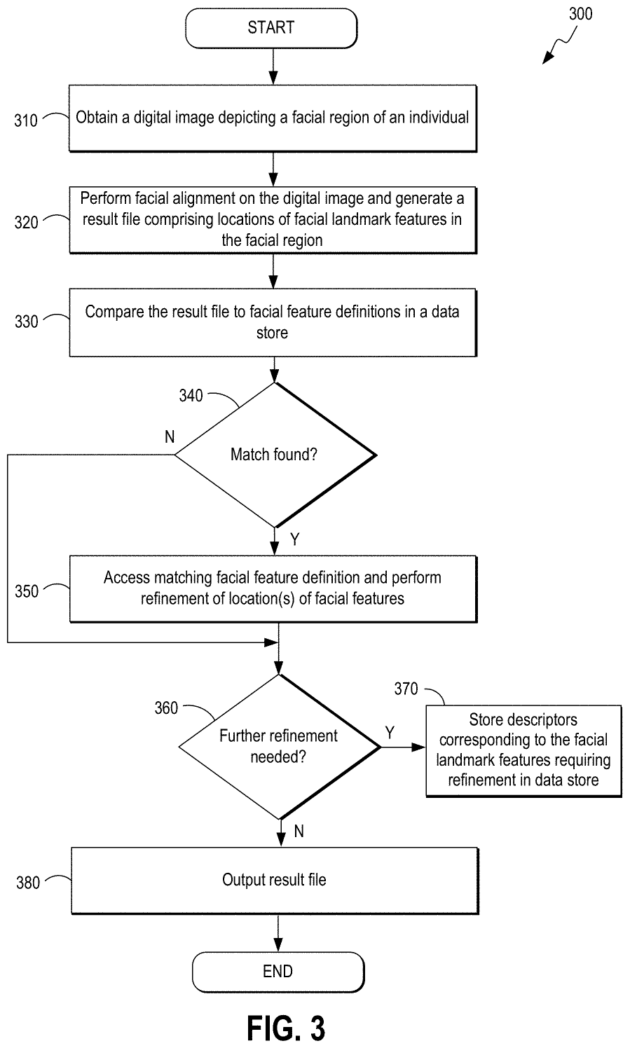

Reference is made to FIG. 3, which is a flowchart 300 in accordance with various embodiments for performing facial feature detection by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

At block 310, the computing device 102 obtains a digital image depicting a facial region of an individual. At block 320, the computing device 102 performs facial alignment on the digital image and generates a result file comprising initial estimated locations of facial landmark facial features in the facial region. At block 330, the computing device 102 compares the facial feature definition generated from the result file to facial feature definitions 118 in a data store 116 to determine whether the facial region depicted in the current digital image matches a facial region previously processed by the computing device 102.

At decision block 340, the computing device 102 determines whether the facial feature definition generated from the result file matches one of the facial feature definitions 118 in the data store 116. If a match is found, then at block 350, the computing device 102 accesses the matching facial feature definition 118 in the data store 116 and performs automatic refinement of location(s) of facial features in the current digital image. Specifically, responsive to the facial feature definition generated from the result file matching one of the facial feature definitions 118, the computing device 102 accesses the matching facial feature definition 118 and applies the corresponding refinement data to a corresponding location of a facial landmark feature in the digital image to generate a refined result file with a refined location for one or more facial landmark facial features.

For some embodiments, the refinement data comprises descriptor data, wherein the descriptor data may comprise scale-invariant feature transform (SIFT) data, histogram of oriented gradients (HOG) data, or Haar-like feature data. For some embodiments, the computing device 102 compares the facial feature definition generated from the result file to facial feature definitions 118 in the data store 116 by comparing descriptor data of the facial feature definition generated from the result file with descriptor data of each of the facial feature definitions in the data store. If no further refinement is needed for locations of any of the facial landmark facial features in the digital image (decision block 360), the computing device 102 outputs the refined result file.

On the other hand, if a match is found but further refinement is needed for locations of one or more of the facial landmark facial features in the digital image, the computing device 102 obtains further refinement of one or more locations of facial landmark facial features, adjusts the one or more locations, and stores descriptors corresponding to the facial landmark facial features with further refined locations in the data store 116. In particular, in block 370, the descriptors associated with the refined locations are stored in the matching facial feature definition 118 identified earlier by the computing device 102. The computing device 102 may obtain further refinement of one or more locations of facial landmark facial features by tracking manual adjustments performed by a user to the locations of facial landmark facial features.

Referring back to decision block 340, if no match is found, then at decision block 360, the computing device 102 determines whether further refinement of any of the facial features locations is needed. If further refinement is needed, then at block 370, the computing device 102 performs further refinement of the location(s) of the facial features and stores the corresponding descriptors for the refined location(s) in the data store 116. If no further refinement is needed, then at block 380, the computing device 102 outputs the result file, which contains the locations of facial landmark facial features in the current digital image. Referring back to decision block 340, if no match was found earlier, the facial feature definition generated from the result file is stored as a new facial feature definition 118 in the data store 116. On the other hand, if a match was found earlier, the result file is stored as part of the matching facial feature definition 118. Thereafter, the process in FIG. 3 ends.

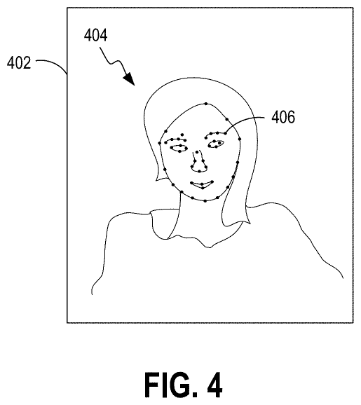

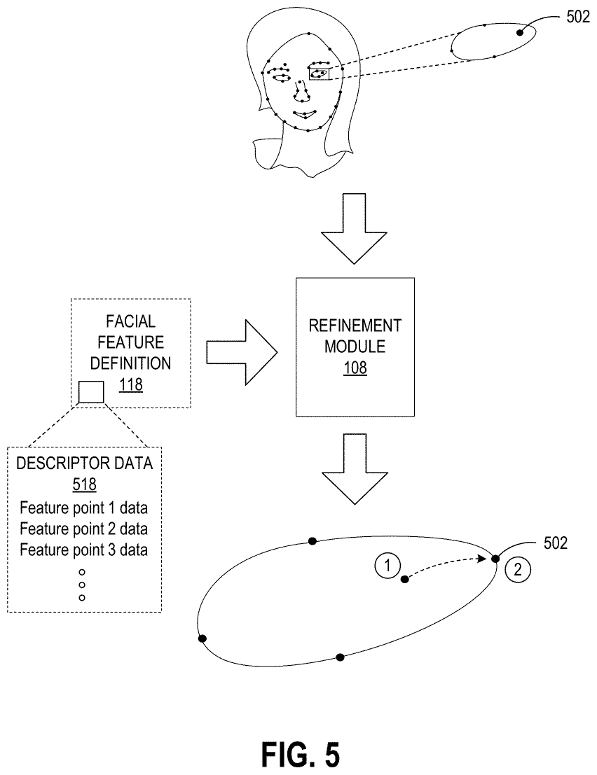

Having described the basic framework of a system for performing facial feature detection, reference is made to FIGS. 4 and 5, which further illustrate various features disclosed above. FIG. 4 illustrates a digital image 402 depicting a facial region 404 with landmark facial features 406 identified by the computing device 102 in FIG. 1 using a facial alignment technique. The computing device 102 generates a result file based on the initial estimated locations of the landmark facial features 406 shown. As discussed above, the computing device 102 then accesses the data store 116 (FIG. 1) and compares the facial feature definition generated from the result file to each of the facial feature definitions 118 (FIG. 1) to determine whether the facial region 404 depicted in the digital image 402 corresponds to a facial region previously processed by the computing device 102.

If a match is found between the facial feature definition generated from the result file and a facial feature definition 118 in the data store 116, the computing device 102 retrieves the matching facial feature definition 118 and accesses any refinement data corresponding to the facial feature definition 118. Such refinement data reflects previous adjustments made to one or more locations of landmark facial features 406. The computing device 102 then applies such refinement data to the locations of the landmark facial features 406 in the current digital image 402 (FIG. 4) being processed.

FIG. 5 illustrates the computing device 102 of FIG. 1 adjusting the location of a landmark facial feature 502. Assume for purposes of illustration that a matching facial feature definition 118 (FIG. 1) is found in the data store 116 (FIG. 1). Based on this, the computing device 102 retrieves refinement data associated with the matching facial feature definition 118. As discussed above, such refinement data may comprise descriptor data 518 that may include scale-invariant feature transform (SIFT) data, histogram of oriented gradients (HOG) data, or Haar-like feature data. As shown, the computing device 102 utilizes the descriptor data 518 to automatically adjust the location of the landmark facial feature 502.

If no match is found, the computing device 102 determines that a new facial region 404 (FIG. 4) is depicted in the digital image 402. The computing device 102 then determines whether further refinement is needed for any of the landmark facial features 406 (FIG. 4). For some embodiments, the computing device 102 makes this determination by displaying a dialog box to the user. If the user indicates that further refinement is needed for the location of one or more landmark facial features 406, the computing device 102 allows the user to manually adjust the location of the target landmark facial feature 502. This may comprise, for example, the user dragging the target landmark facial feature 502 requiring refinement to a new location. The computing device 102 then generates a new facial feature definition 118 and stores the new facial feature definition 118 in the data store 116. The computing device 102 also stores the descriptor data for the target landmark facial feature 502.

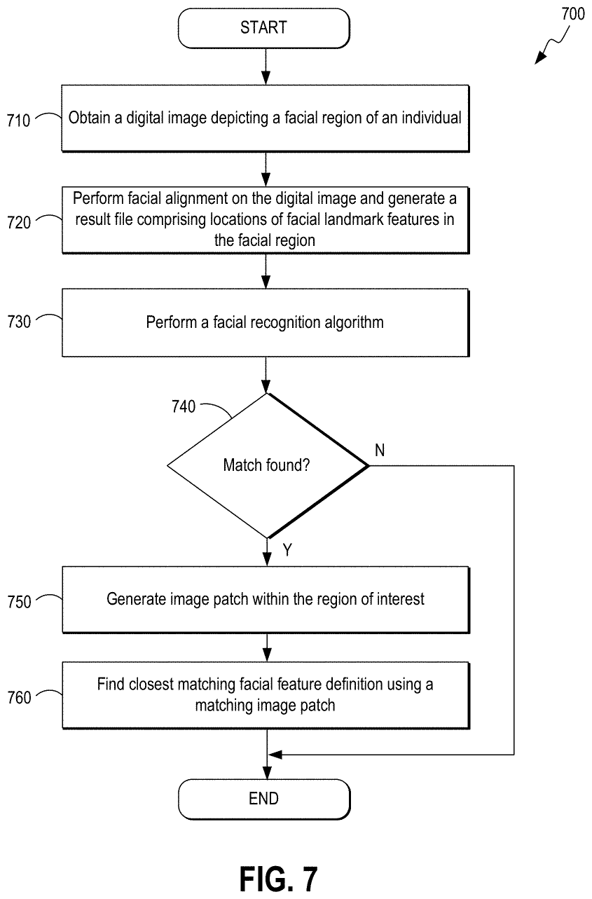

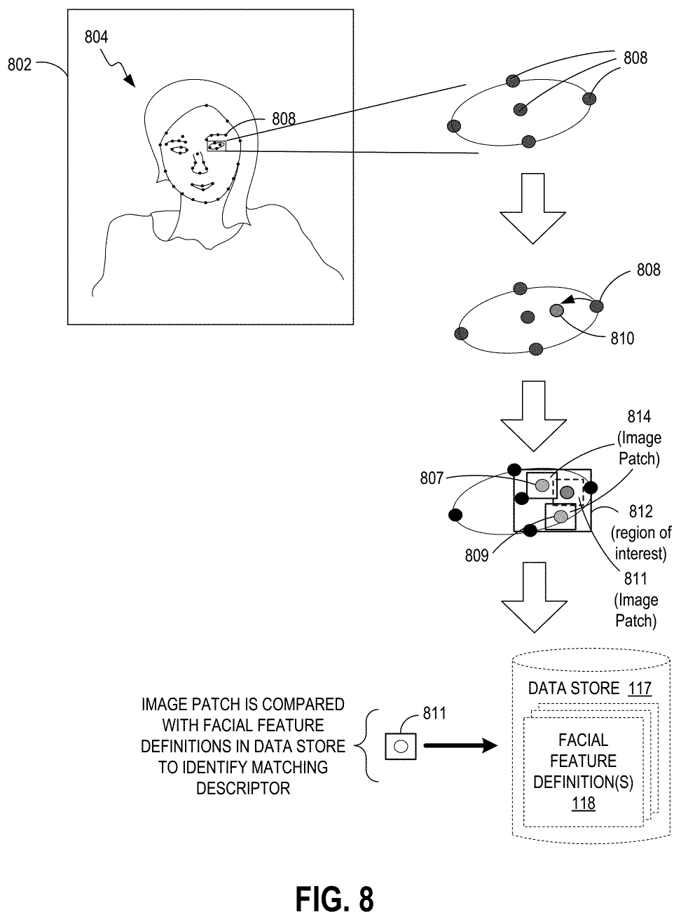

Reference is made to FIG. 6, which is a flowchart 600 for generating result files performed by the computing device 102 of FIG. 1. Specifically, the flowchart 600 in FIG. 6 depicts a process whereby descriptor data is generated and stored in the data store 116 (FIG. 1) for future use, as described in connection with FIG. 7 below. The operations below are also described in connection with FIG. 8, which illustrates a digital image 802 depicting a facial region 804 with facial landmark facial features represented by points 808 identified by the computing device 102 in FIG. 1 using a facial alignment technique.

It is understood that the flowchart 600 of FIG. 6 provides merely an example of the different types of functional arrangements that may be employed to implement the operation of the various components of the computing device 102. As an alternative, the flowchart 600 of FIG. 6 may be viewed as depicting an example of steps of a method implemented in the computing device 102 according to one or more embodiments.

Although the flowchart 600 of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. It is understood that all such variations are within the scope of the present disclosure.

In block 610, the computing device 102 obtains a digital image. In block 620, the computing device 102 performs facial alignment on the digital image and generates a facial alignment result file, which defines the location of landmark facial features represented by points 808 in FIG. 8. In block 630, the computing device 102 displays the facial alignment result file to the user and obtains user adjustments comprising two-dimensional (2D) offsets for one or more landmark facial features identified in the facial alignment result file. In particular, the user adjusts the location of one or more points 808 as needed.

In the example shown in FIG. 8, the location of a point 808 is moved to a new location (as shown by the arrow) to generate adjusted point 810. In block 640, the computing device 102 stores the location data of the one or more user-adjusted points 810 in the data store 116 to generate an image patch 811 as descriptor data, where the image patch 811 is extracted around each of the adjusted points 810. This descriptor data is then stored in the data store 116 for future comparisons, as described below in FIG. 7. Such descriptor data may comprise scale-invariant feature transform (SIFT) data, histogram of oriented gradients (HOG) data, or Haar-like feature data. Thereafter, the process in FIG. 6 ends.

Reference is made to FIG. 7, which is a flowchart 700 for utilizing previously-stored descriptor data for facial feature detection performed by the computing device 102 of FIG. 1. Specifically, the flowchart 700 in FIG. 7 illustrates the use of previously-stored descriptor data, where the generation and storage of the descriptor data was described above in connection with FIG. 6. It is understood that the flowchart 700 of FIG. 7 provides merely an example of the different types of functional arrangements that may be employed to implement the operation of the various components of the computing device 102. As an alternative, the flowchart 700 of FIG. 7 may be viewed as depicting an example of steps of a method implemented in the computing device 102 according to one or more embodiments.

Although the flowchart 700 of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. It is understood that all such variations are within the scope of the present disclosure.

In block 710, the computing device 102 obtains another digital image. In block 720, the computing device 102 performs facial alignment on the digital image and generates a facial alignment result file, which defines the location of landmark facial features represented by points 808 in FIG. 8. In block 730, the computing device 102 performs a facial recognition algorithm on the face depicted in the digital image and determines whether the face depicted in the digital image already exists in the data store 116 (FIG. 1). In particular, the computing device 102 determines whether the detected facial region matches a facial feature definition 118 previously stored in the data store 116.

For some embodiments, the facial feature definition previously-stored in the data store 116 was generated based on user adjustments made to a result file comprising locations of facial landmark facial features in a facial region corresponding to the facial feature definition, where the locations of the user adjustments were stored to generate the image patch as descriptor data in the facial feature definition. For some embodiments, the descriptor data further comprises scale-invariant feature transform (SIFT) data, histogram of oriented gradients (HOG) data, or Haar-like feature data. For some embodiments, image patches around each location of the user adjustments are stored with the facial feature definition, where each image patch comprises a region of a predetermined size.

At decision block 740, if the face depicted in the digital image 802 already exists in the data store 116, the computing device 102 identifies a region of interest 812 (FIG. 8) based on the location of the points 808 corresponding to landmark facial features. At block 750, the computing device 102 generates one or more suggested points 807, 809 within the region of interest 812 and generates corresponding image patches 814 around the suggested points 807, 809. The image patches 814 represent descriptor data.

For some embodiments, the region of interest 812 is defined based on locations of the identified landmark facial features, where the image patch comprises a region of a predetermined size around suggested landmark facial features within the region of interest. For some embodiments, the closest matching facial region definition is identified using the descriptor data in response to the facial region matching a facial feature definition 118 previously-stored in the data store 116.

In block 760, the computing device 102 finds the closest matching facial feature definition 118 (FIG. 1) previously archived in the data store 116 based on the descriptor data. Referring back to decision block 740, if the detected facial region does not match a facial region already stored in the data store 116, this signifies that a new facial region has been detected and that a corresponding descriptor was not found in the data store 116. That is, points 808 were not previously adjusted by the user. This new facial region is than processed as described earlier in connection with FIG. 6. No further steps are performed, and thereafter, the process in FIG. 7 ends.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a computing device, comprising:
obtaining a digital image depicting a facial region of an individual;
performing a facial alignment algorithm to generate a facial alignment result depicted in a digital image to identify landmark facial features in the facial region;
performing a facial recognition algorithm on the facial region to determine whether the facial region matches a facial feature definition previously-stored in a data store;
generating descriptor data comprising an image patch within a region of interest and identifying a closest matching facial feature definition using the descriptor data; and
modifying a landmark facial feature based on the identified closest matching facial feature definition.

2. The method of claim 1, wherein the region of interest is defined based on locations of the identified landmark facial features, and wherein the image patch comprises a region of a predetermined size around suggested landmark facial features within the region of interest.

3. The method of claim 1, wherein identifying the closest matching facial feature definition using the descriptor data is performed in response to matching a facial feature definition previously-stored in the data store.

4. The method of claim 1, further comprising determining that the facial region is a new facial region in response to determining that the facial region does not match a facial feature definition previously-stored in the data store.

5. The method of claim 1, wherein the facial feature definition previously-stored in the data store was generated based on user adjustments, wherein locations of the user adjustments were stored to generate the image patch as descriptor data in the facial feature definition.

6. The method of claim 5, wherein the descriptor data further comprises one of: scale-invariant feature transform (SIFT) data; histogram of oriented gradients (HOG) data; or Haar-like feature data.

7. The method of claim 5, wherein image patches around each location of the user adjustments are stored with the facial feature definition, wherein each image patch comprises a region of a predetermined size.

8. A system, comprising:
a memory storing instructions;
a processor coupled to the memory and configured by the instructions to at least:
obtain a digital image depicting a facial region of an individual;
perform a facial alignment algorithm to generate a facial alignment result depicted in a digital image to identify landmark facial features in the facial region;
perform a facial recognition algorithm on the facial region to determine whether the facial region matches a facial feature definition previously-stored in a data store;
generate descriptor data comprising an image patch within a region of interest and identifying a closest matching facial feature definition using the descriptor data; and
modify a landmark facial feature based on the identified closest matching facial feature definition.

9. The system of claim 8, wherein the region of interest is defined based on locations of the identified landmark facial features, and wherein the image patch comprises a region of a predetermined size around suggested landmark facial features within the region of interest.

10. The system of claim 8, wherein the processor identifies the closest matching facial feature definition using the descriptor data in response to matching a facial feature definition previously-stored in the data store.

11. The system of claim 8, wherein the processor is further configured to determine that the facial region is a new facial region in response to determining that the facial region does not match a facial feature definition previously-stored in the data store.

12. The system of claim 8, wherein the facial feature definition previously-stored in the data store was generated based on user adjustments, wherein locations of the user adjustments were stored to generate the image patch as descriptor data in the facial feature definition.

13. The system of claim 12, wherein the descriptor data further comprises one of: scale-invariant feature transform (SIFT) data; histogram of oriented gradients (HOG) data; or Haar-like feature data.

14. The system of claim 12, wherein image patches around each location of the user adjustments are stored with the facial feature definition, wherein each image patch comprises a region of a predetermined size.

15. A non-transitory computer-readable storage medium storing instructions to be implemented by a computing device having a processor, wherein the instructions, when executed by the processor, cause the computing device to at least:
obtain a digital image depicting a facial region of an individual;
perform a facial alignment algorithm to generate a facial alignment result depicted in a digital image to identify landmark facial features in the facial region;
perform a facial recognition algorithm on the facial region to determine whether the facial region matches a facial feature definition previously-stored in a data store;
generate descriptor data comprising an image patch within a region of interest and identifying a closest matching facial feature definition using the descriptor data; and
modify a landmark facial feature based on the identified closest matching facial feature definition.

16. The non-transitory computer-readable storage medium of claim 15, wherein the region of interest is defined based on locations of the identified landmark facial features, and wherein the image patch comprises a region of a predetermined size around suggested landmark facial features within the region of interest.

17. The non-transitory computer-readable storage medium of claim 15, wherein the processor identifies the closest matching facial feature definition using the descriptor data in response to matching a facial feature definition previously-stored in the data store.

18. The non-transitory computer-readable storage medium of claim 15, wherein the processor is further configured to determine that the facial region is a new facial region in response to determining that the facial region does not match a facial feature definition previously-stored in the data store.

19. The non-transitory computer-readable storage medium of claim 15, wherein the facial feature definition previously-stored in the data store was generated based on user adjustments, wherein locations of the user adjustments were stored to generate the image patch as descriptor data in the facial feature definition.

20. The non-transitory computer-readable storage medium of claim 19, wherein the descriptor data further comprises one of: scale-invariant feature transform (SIFT) data; histogram of oriented gradients (HOG) data; or Haar-like feature data.
